(19) United States
(12) Patent Application Publication
(10) Pub. No.: US 2016/0248313 A1
(43) Pub. Date: Aug. 25, 2016

(54) Electric Water Pump

(71) Applicant: Hitachi Automotive Systems, Ltd., Hitachinaka-shi (JP)

(72) Inventors: Shohichi KAWAMATA, Tokyo (JP); Yuji ENOMOTO, Tokyo (JP); Kunihiko NORIDUKI, Tokyo (JP); Kenya TAKARAI, Hitachinaka (JP)

(21) Appl. No.: 15/041,832

(22) Filed: Feb. 11, 2016

(30) Foreign Application Priority Data
Feb. 19, 2015 (JP) 2015-030146

(51) Int. Cl. H02K 49/10; F04D 29/18; F04D 29/66; H02K 7/00; H02K 1/27; H02K 21/24; H02K 16/02; F04D 29/22; F04D 13/06

(52) U.S. Cl. CPC H02K 49/106; F04D 29/22; F04D 29/181; F04D 29/669; F04D 13/06; H02K 1/2793; H02K 21/24; H02K 16/02; H02K 7/003

(57) ABSTRACT

Provided is a highly reliable and compact electric water pump. A motor unit includes an axial gap motor having a stator and rotors. A partition formed with a nonmagnetic member is interposed between the motor unit and a pump unit. A torque generated by the motor unit is transmitted to the pump unit by a contactless magnetic coupling in an axial direction. The partition is formed to have a bottomed cylindrical shape. The motor unit and pump unit are provided with driving magnets and passive magnets respectively which are opposed to each other with a cylindrical part of the partition between them.

### CLAIM OF PRIORITY

The present application claims priority from Japanese Patent applications serial No. 2015-30146, filed on Feb. 19, 2015, the respective contents of which are hereby incorporated by reference into this application.

### FIELD OF THE INVENTION

The present invention relates to an electric water pump. More particularly, the present invention is concerned with an electric water pump having a pump unit and motor unit connected to each other by a magnetic coupling.

### BACKGROUND OF THE INVENTION

In recent years, the necessity of energy saving has come to be emphasized in the field of industrial equipment, home electric appliances, or automotive parts. At present, a half or more of an amount of electric power used within the nation is consumed for driving of rotary electric machines. 70% or more of the use of electric power is occupied by the use for electrical operation, or especially, the use for systems employing an impeller, such as, motor-driven pumps and ventilation fans. As for the use for power generation, the use of electric power is attributable to utilization of a system employing an impeller such as a water-wheel generator. A typical motor-driven pump has a motor unit and pump unit coupled to each other by a shaft, and has a motor used as a driving source. In this case, a shaft coupling and other coupling parts are arranged in an axial direction. This poses a problem in that the dimension in the axial direction gets longer. In an attempt to shorten the dimension in the axial direction, a motor-integrated pump having the shaft of the motor directly coupled to an impeller has been put on the market. However, since the pump unit is filled with water or any other liquid, a pump chamber in which the impeller rotates has to be sealed for fear the liquid may leak out. Even in the motor-integrated pump, the sealing is achieved in a space between the pump chamber and motor. As a structure of achieving the sealing for fear the liquid may leak out, a structure of disposing an O ring formed with a rubber member or an oil seal is adopted. A structure of achieving the sealing via a rotating piece such as a shaft has a drawback that regular maintenance is needed.

Patent literature 1 (Japanese Patent Application Laid-Open No. 6-280779) discloses a liquid pump system that has a rotator incorporated in it, and that includes a pump body which feeds a liquid from the inside by means of the rotation of the rotator, and a motor which is disposed outside the pump body and transmits the rotation of a rotor to the rotator using a magnetic coupling. Herein, the rotor includes a first magnet that is a driving magnet which forms the magnetic coupling and that serves as a rotor magnet of the motor. The rotator includes a second magnet that is a driven magnet which forms the magnetic coupling and that is driven to rotate due to a magnetic field induced by the first magnet.

In a pump system having a structure like the one disclosed in the patent literature 1, a driving magnet that forms a magnetic coupling is also used as a motor magnet that is presumably included in an axial motor structure. A transmission torque cannot therefore be increased. For adapting the disclosed structure to a pump system that is intended to exert a large torque, a motor unit has to be large in size.

### SUMMARY OF THE INVENTION

An object of the present invention is to provide a highly reliable and compact electric water pump.

The present invention adopts a structure of an electric water pump having a motor unit which includes an axial gap motor and driving magnets, and a pump unit which includes passive magnets that are magnetically coupled to the driving magnets in a radial direction.

According to an aspect of the present invention, a highly reliable and compact electric water pump can be provided.

### BRIEF DESCRIPTION OF THE DRAWINGS

FIG. 1 is a sectional diagram of an electric water pump 100;

FIG. 2 is an exploded perspective diagram of a pivotal part of the electronic water pump 100;

FIG. 3 is a sectional diagram of a motor unit 200;

FIG. 4 is an exploded perspective diagram of a pivotal part of the motor unit 200;

FIG. 5A is a perspective diagram of an output-side rotor 230;

FIG. 5B is a perspective diagram of the output-side rotor 230;

FIG. 6 is a sectional diagram of a partition 10;

FIGS. 7A-7D are a perspective diagram showing a structure of an iron core of an axial gap motor;

FIG. 8 is a sectional schematic diagram of an output-side rotor 230 of another embodiment; and

FIG. 9 is a sectional schematic diagram of the output-side rotor 230 of still another embodiment.

### DESCRIPTION OF THE PREFERRED EMBODIMENTS

Referring to the drawings, embodiments of the present invention will be described below.

### First Embodiment

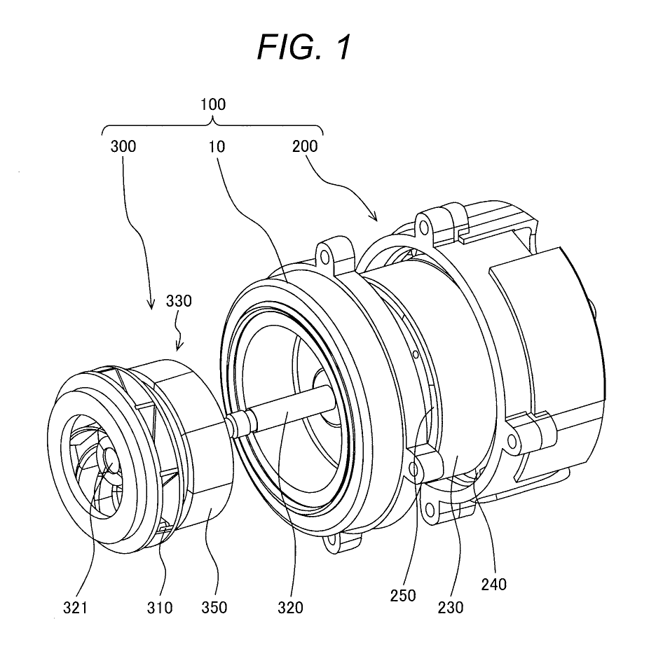

A first embodiment will be described below in conjunction with FIG. 1 to FIG. 6.

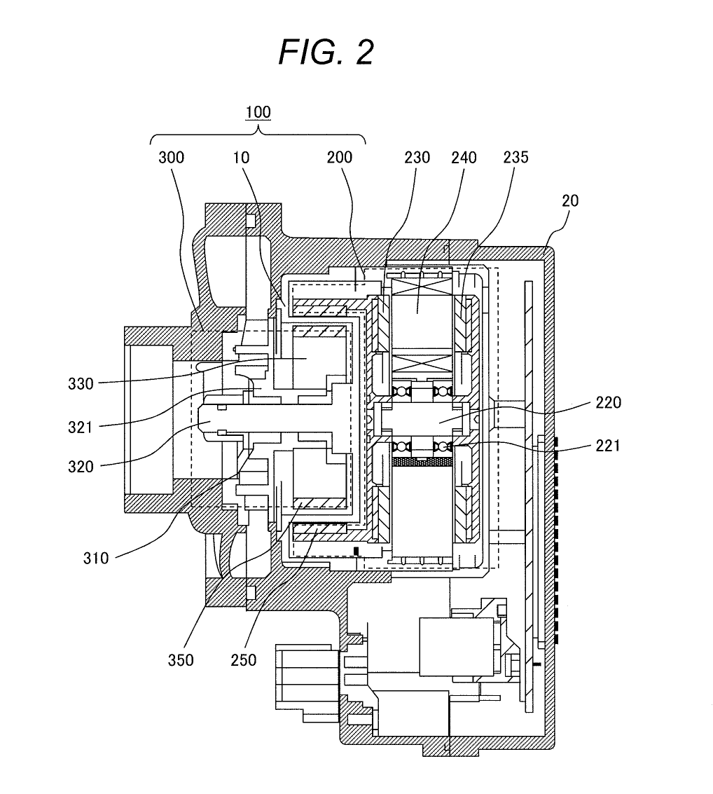

FIG. 1 is an exploded perspective diagram of major parts of an electric water pump 100 in accordance with the present embodiment. The electric water pump 100 broadly includes a motor unit 200 and pump unit 300. The motor unit 200 and pump unit 300 are separated from each other with a partition 10 between them. FIG. 2 is a sectional diagram of the electric water pump 100. The motor unit 200 and pump unit 300 are stored in a housing 20.

The electric water pump 100 of the present embodiment is characterized by such points that an axial gap motor is included in the motor unit 200 and that a radial magnetic coupling in which the partition 10 intervenes is adopted to transfer power between the motor unit 200 and pump unit 300. The structure will be described below.

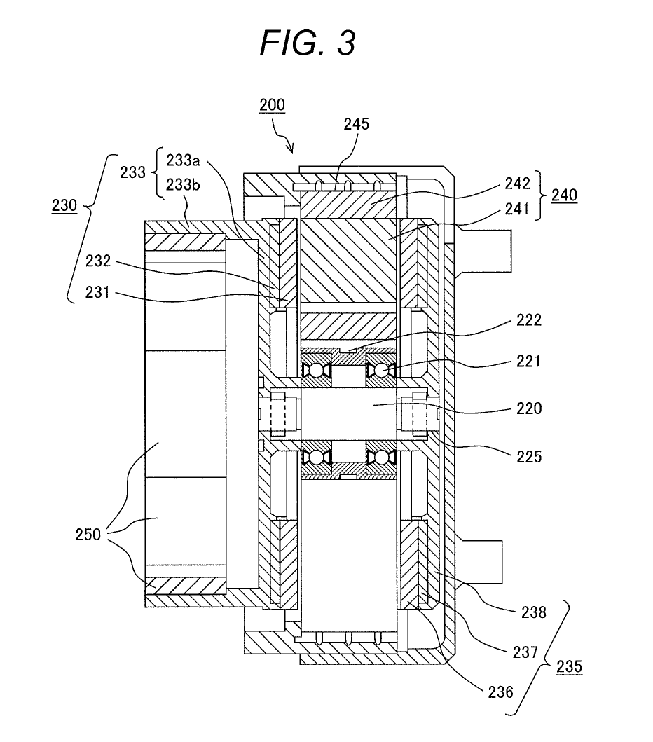

FIG. 3 is an enlarged sectional diagram of the motor unit 200 shown in FIG. 2. The motor unit 200 includes a motor stator 240, motor rotors 230 and 231, and a motor-side shaft 220. The motor unit 200 included in the present embodiment includes an axial gap motor that has the motor stator 240 and motor rotors 230 and 231 arranged in an axial direction with predetermined gaps among them.

The axial gap motor includes plural motor stator iron cores 241 in the circumferential direction of the motor-side shaft 220. A motor stator coil 242 is wound about the periphery of each of the motor stator iron cores 241, whereby the motor stator 240 is formed. The motor stator 240 is disposed substantially in the center in the axial direction of the motor-side shaft 220.

An output-side rotor 230 and anti-output-side rotor 235 are arranged on both sides of the motor stator 240 in the axial direction. The output-side rotor 230 is disposed on the left side in FIG. 3, and the anti-output-side rotor 235 is disposed on the right side in FIG. 3. Gaps among the stator 240 and the rotors 230 and 235 which constitute the motor unit 200 are designed to have an appropriate dimensional relationship for the purpose of exerting maximum efficiency.

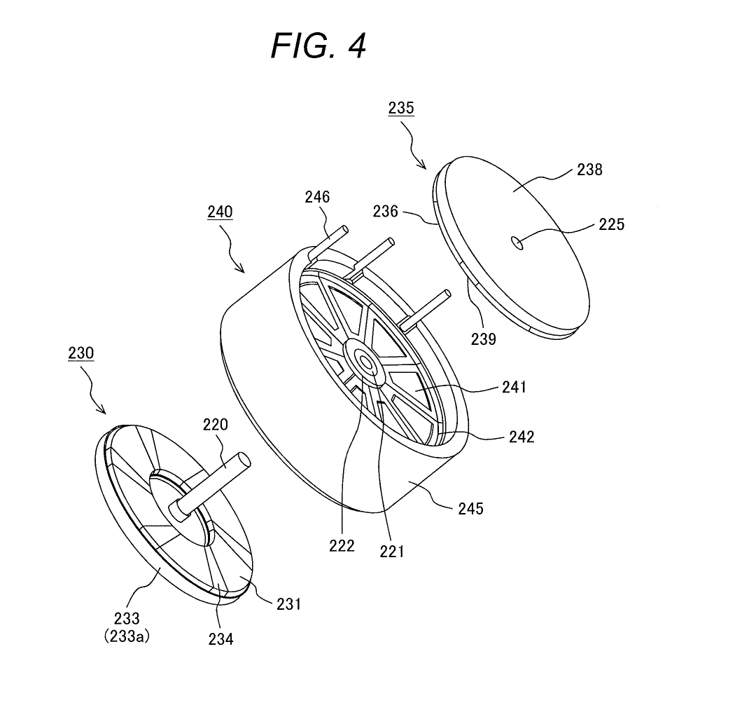

FIG. 4 is an exploded perspective diagram showing the output-side rotor 230, anti-output-side rotor 23 5, and motor stator 240 out of the parts constituting the motor unit 200.

The anti-output-side rotor 235 has anti-output-side rotor magnets 236 retained on one of surfaces of a substantially disk-like anti-output-side rotor yoke 238 with an anti-output-side rotor heel piece 237 between them. In the present embodiment, the plural anti-output-side rotor magnets 236 are disposed while being separated in the circumferential direction. An anti-output-side magnet positioning member 239 is interposed between adjoining ones of the plural anti-output-side rotor magnets 236. A shaft insertion hole 225 into which the motor-side shaft 220 is inserted and fitted is formed in the center of the anti-output-side rotor yoke 238.

The motor stator 240 has, as mentioned above, the plural motor stator iron cores 241 each of which has the motor stator coil 242 wound about it. In the present embodiment, nine pairs of the motor stator iron core 241 and motor stator coil 242 are disposed in the circumferential direction of the motor-side shaft 220. A motor-side bearing retainer 222 is formed in the center of the motor stator 240. A motor-side bearing 221 is fitted into the motor-side bearing retainer 222.

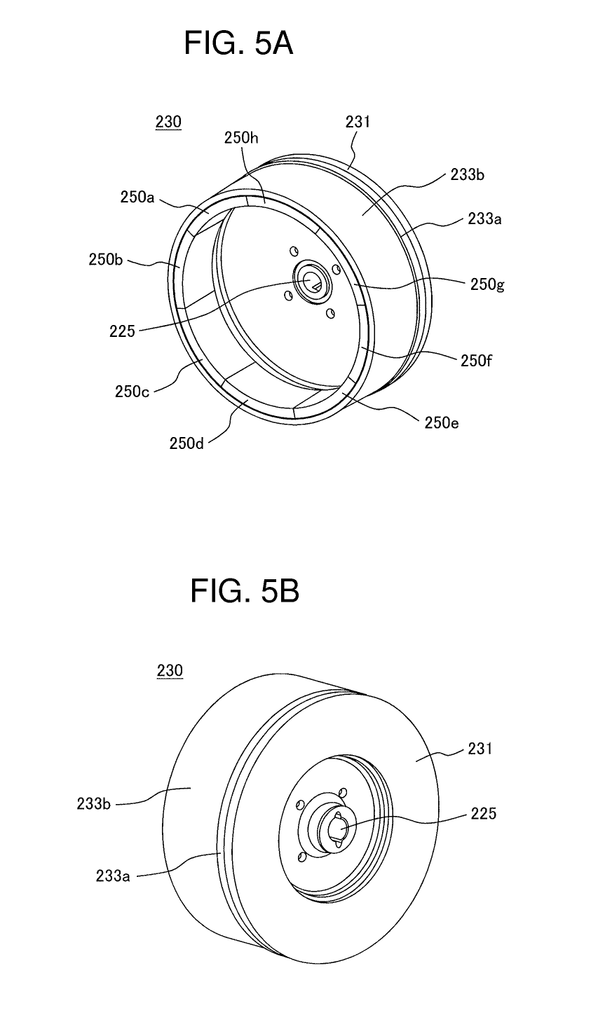

The output-side rotor 230 has substantially the same structure as the anti-output-side rotor 235. The output-side rotor 230 has output-side rotor magnets 231 retained on one of surfaces of a substantially disk-like output-side rotor yoke 233 with an output-side rotor heel piece 232 between them. An output-side magnet positioning member 234 is interposed between adjoining ones of the plural output-side rotor magnets 231 that are separated in the circumferential direction. The output-side rotor yoke 233 retains the output-side rotor magnets 231 on the surface of the output-side rotor yoke on which the motor stator 240 is disposed. Further, the output-side rotor yoke 233 has a cylindrical yoke, which looks like the one shown in FIG. 5A and FIG. 5B, formed on the surface opposite to the surface on which the motor stator 240 is disposed.

Referring to FIG. 5A and FIG. 5B, the structure of the output-side rotor 230 included in the electric water pump of the present embodiment will be described below. FIG. 5A is a perspective diagram showing the output-side rotor 230 seen on the side of the pump unit 300. FIG. 5B is a perspective diagram showing the output-side rotor 230 seen on the side of the motor stator 240.

The output-side rotor yoke 233 included in the present embodiment is formed to have a bottomed cylindrical shape with a part, the back of which retains the output-side rotor magnets 231, as a bottom. Specifically, the output-side rotor yoke 233 includes an output-side rotor yoke bottom 233a and output-side rotor yoke cylinder 233b. The output-side rotor yoke cylinder 233b is formed on a side opposite to a side, on which the output-side rotor magnets 231 are formed, with the output-side rotor yoke bottom 233a between them. The output-side rotor yoke bottom 233a and output-side rotor yoke cylinder 233b are formed to have substantially the same outer diameter. In the present embodiment, the output-side rotor yoke bottom 233a and output-side rotor yoke cylinder 233b are made of a material such as iron, aluminum, or stainless steel to be integrated into one body.

Motor-side magnets 250 that are magnetized to have plural poles are retained on the internal circumference of the output-side rotor yoke cylinder 233b. The motor-side magnets 250 are formed like arcs along the internal circumference of the output-side rotor yoke cylinder 233b. In the present embodiment, a total of eight motor-side magnets 250 are arranged in the circumferential direction so that adjoining magnets have reverse poles. Herein, when seen from the pump unit 300 along the motor-side shaft 220, the motor-side magnets 250a, 250b, 250c, 250d, 250e, 250f, 250g, and 250h are counterclockwise arranged in that order.

The output-side rotor magnets 231 may be, as shown in FIG. 5B, formed with donut-like ring magnets. In this case, the output-side rotor magnets 231 can have plural magnetic poles alternated in a circumferential direction. The ring magnets can concurrently take on the plural polarities as an integrated body during magnetization. Thus, the output-side rotor magnets 231 that are highly precise and cause a little error can be obtained. At this time, since the direction of magnetization for the output-side rotor magnets 231 is orthogonal to the direction of magnetization for the motor-side magnets 250, adverse effects on the magnets 231 and magnets 250 respectively due to magnetization are limited. In addition, since the necessity of the magnet positioning members like the ones shown in FIG. 4 is obviated, the number of parts can be decreased.

The present embodiment has eight magnetic poles. However, as long as the number of magnetic poles refers to an integral multiple of a pair of poles (north and south), any number of magnetic poles will do. The electric water pump of the present embodiment makes it possible to independently design the number of poles of rotor magnets included in an axial gap motor, and the number of poles of driving magnets and passive magnets which form a magnetic coupling between the motor unit and pump unit.

Referring back to FIG. 2, the relationship between the motor unit 200 and pump unit 300 will be described below. As mentioned above, the motor unit 200 and pump unit 300 are disposed in the housing 20 with the partition 10 between them. The partition 10 is non-conductive and preferably made of a nonmagnetic material. However, if the partition 10 is made of a resin material such as plastic, a desired strength cannot be ensured depending on the thickness of the partition 10. Therefore, the partition may be formed with a nonmagnetic metal such as stainless steel.

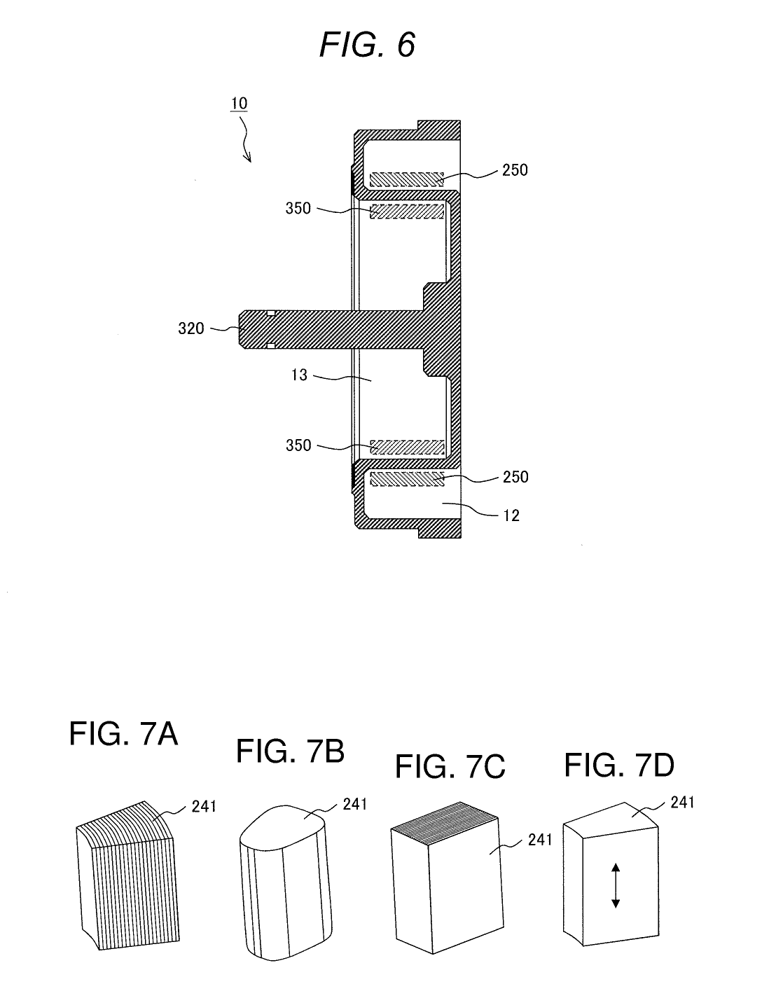

FIG. 6 is a partially sectional diagram of the partition 10 shown in FIG. 2. In FIG. 6, the locations of the motor-side magnets 250 and pump-side magnets 350 which will be described later are also hatched.

The partition 10 includes a bottomed cylindrical part 13 that is formed along the internal surface of the output-side rotor yoke 233 formed to have a bottomed cylindrical shape. The pump unit 300 is disposed in a space formed with the bottomed cylindrical part 13 of the partition 10.

The partition 10 further includes a pump-side shaft 320 that extends from the center of the bottom of the bottomed cylindrical part 13 in a direction parallel to the axial direction of the motor-side shaft 220. The pump-side shaft 320 is disposed coaxially with the motor-side axis 220.

The partition 10 further includes a bottomed annular part 12 that opens in a direction, in which the motor unit 200 is disposed, outside the bottomed cylindrical part 13 in the radial direction. In a space formed with the bottomed annular part 12 of the partition 10, the output-side rotor yoke cylinder 233b and output-side rotor magnets 231 are disposed.

As shown in FIG. 2, a pump-side rotor 330 is disposed in the bottomed cylindrical part 13. The pump-side rotor 330 is retained by a pump-side bearing 321 located in the center of the pump-side rotor 330 so that the pump-side rotor 330 can be rotated about the pump-side shaft 320. The pump-side magnets 350 are arranged on the periphery of the pump-side rotor 330 in the radial direction of the pump-side rotor 330. The pump-side magnets 350 are provided with the same number of poles as the number of poles of the motor-side magnets 250. In the present embodiment, eight pump-side magnets 350 are included (see FIG. 1).

Accordingly, the motor-side magnets 250 and pump-side magnets 350 are magnetically coupled to each other, and a torque is transmitted in a contactless manner with the partition 10 between the motor-side magnets 250 and pump-side magnets 350. Since the permanent magnets are opposed to the other permanent magnets in a radial direction, a gap magnetic flux can be increased. Therefore, a larger torque can be transmitted by means of a magnetic coupling. Although the structure including gaps derived from the presence of the partition 10 is adopted, a torque generated by the motor unit 200 can be transmitted over one plane. In addition, the outer diameter of a contactless torque transmission plane can be decreased if necessary.

The driving magnets that are magnetically coupled to the passive magnets are disposed without a joint member on the side of the driving shaft of the motor unit. Therefore, a highly reliable pump system can be constructed.

Similarly to the pump-side rotor 330, an impeller 310 is disposed to be able to rotate about the pump-side shaft 320. The impeller 310 is fixed to a screw, which is located at the distal end of the pump-side shaft 320, in a thrust direction using an impeller fastening washer and impeller fastening nut which are not shown.

In the present embodiment, the outer diameter of the pump-side magnets 350 is smaller than the outer diameter of the impeller 310 (see FIG. 1). Accordingly, a fluid such as water, oil, or air that flows through the impeller 310 flows smoothly. This exerts an effect of preventing breakdown of the impeller 310, which is derived from turbulence, or reducing noise.

The magnetic coupling between the pump unit and motor unit is attained with a radial structure. This prevents such an incident that the motor-side magnets 250 that are driving magnets and the partition 10 come into contact with each other because of a change in the internal pressure of the pump unit. Eventually, reliability improves.

FIG. 7A to FIG. 7D show examples of other structures of the motor stator iron cores 241 of the motor unit 200. FIG. 7A shows an iron core that is structured by layering electromagnetic steel sheets or foils, which are made of such a material as iron-based amorphous, FINEMET, or nanocrystal, in a circumferential direction. FIG. 7B shows an example in which a dust core or an iron core formed by compressively molding powder of ferrite is utilized. FIG. 7C shows an example in which an iron core that is structured by layering electromagnetic steel sheets or foils, which are made of such a material as iron-based amorphous, FINEMET, or nanocrystal, in the circumferential direction has rectangular sections. FIG. 7D shows an iron core formed by appending directionality to an iron core made of a soft magnetic material as shown in any of FIGS. 7A to 7C. In an axial gap motor, since a magnetic flux flows in an axial direction, anisotropy is provided in the direction of the magnetic flux.

In the electric water pump of the present embodiment, a special magnetic material can be adopted as the iron cores of the axial gap motor. Therefore, the motor unit can be designed to be quite efficient.

### Second Embodiment

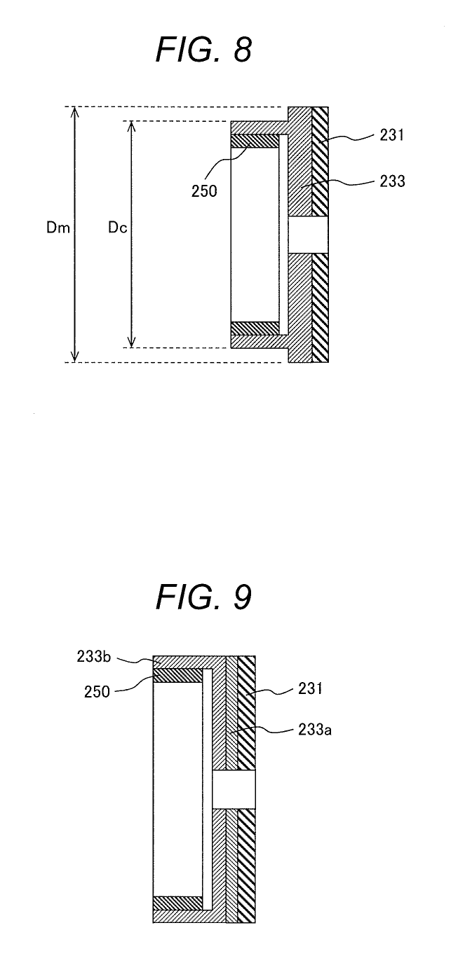

FIG. 8 is a sectional diagram of an output-side rotor 230 of an electric water pump in accordance with a second embodiment.

In the first embodiment, the outer diameter Dm of the output-side rotor yoke bottom 233a and the outer diameter Dc of the output-side rotor yoke cylinder 233b are substantially identical to each other. In the present embodiment, an output-side rotor yoke 233 is formed so that the outer diameter Dc of an output-side rotor yoke cylinder 233b is smaller than the outer diameter Dm of an output-side rotor yoke bottom 233a.

As long as an axial length remains unchanged, the magnitude of a transmission torque provided by a magnetic coupling can be determined with the number of magnetic poles involved in the magnetic coupling and the outer diameter of the magnetic coupling. Therefore, when the structure of the present embodiment is adopted, a magnetic coupling-integrated electric water pump characteristic of a little inertia can be provided.

### Third Embodiment

FIG. 9 is a sectional diagram of an output-side rotor 230 of an electric water pump in accordance with a third embodiment.

In the first embodiment, the output-side rotor yoke bottom 233a that retains the output-side rotor magnets 231 in an axial direction and the output-side rotor yoke cylinder 233b that retains the motor-side magnets 250 in a radial direction are integrated into one member (233). In an output-side rotor yoke included in the present embodiment, an output-side rotor yoke bottom 233a that retains output-side rotor magnets 231 in the axial direction, and an output-side rotor yoke cylinder 233b that retains motor-side magnets 250 in the radial direction are formed as different members. For example, in the present embodiment, the output-side rotor yoke bottom 233a is made of iron, while the output-side rotor yoke cylinder 233b is made of aluminum. In this case, the inertia of a rotator can be reduced.

The aforesaid electric water pumps of the embodiments can be applied to a wide range of usages in which a compact and highly efficient pump system is needed. For example, the electric water pumps can be applied to general rotator systems including an industrial pump, compressor, industrial fan, water-wheel generation system for small water power usages, onboard electric water pump, onboard electric oil pump, pump for home electric appliances, and ventilator for home electric appliances, and to driving or power generation systems that employ an impeller.

What is claimed is:

1. An electric water pump, comprising:
a motor unit including an axial gap motor and driving magnets; and
a pump unit including passive magnets that are magnetically coupled to the driving magnets in a radial direction.

2. The electric water pump according to claim 1, further comprising a partition interposed between the driving magnets of the motor unit and the passive magnets of the pump unit.

3. The electric water pump according to claim 2, wherein the partition is made of a nonmagnetic material.

4. The electric water pump according to claim 1, wherein the driving magnets are annularly formed, and the passive magnets are arranged on the inner diameter side of the driving magnets.

5. The electric water pump according to claim 1, wherein:
the motor unit includes a stator and rotors that are opposed to the stator in an axial direction; and
each of the rotors includes rotor magnets that have a plurality of magnetic poles, and a rotor yoke that retains the rotor magnets; and
the driving magnets are retained by the rotor yoke.

6. The electric water pump according to claim 5, wherein the rotor yoke is formed to have a bottomed cylindrical shape, the rotor magnets are retained on the bottom of the rotor yoke, and the driving magnets are retained on the inner diameter side of a cylindrical part of the rotor yoke.

7. The electric water pump according to claim 1, wherein the number of magnetic poles on each of the rotors included in the motor unit is different from the number of magnetic poles of the driving magnets.

8. The electric water pump according to claim 1, wherein the driving magnets or passive magnets are formed with a plurality of separate magnets.

9. The electric water pump according to claim 1, wherein the driving magnets or passive magnets are formed with ring-like magnets.

10. The electric water pump according to claim 1, wherein:
the motor unit includes a cylindrical driving magnet yoke that retains the driving magnets; and
the driving magnet yoke is formed so that the outer diameter of the driving magnet yoke is smaller than the outer diameter of the axial gap motor.
